(19) United States
(12) Patent Application Publication
(10) Pub. No.: US 2014/0189867 A1
(43) Pub. Date: Jul. 3, 2014

(54) DDoS ATTACK PROCESSING APPARATUS AND METHOD IN OPENFLOW SWITCH

(71) Applicant: Electronics and Telecommunications Research Institute, Daejeon (KR)

(72) Inventors: Boo Geum JUNG, Daejeon (KR); Young Min KIM, Daejeon (KR); Kyoung-Soon KANG, Daejeon (KR); Kyeong Ho LEE, Daejeon (KR); Hea Sook PARK, Daejeon (KR)

(73) Assignee: Electronics and Telecommunications Research Institute, Daejeon (KR)

(21) Appl. No.: 14/080,439

(22) Filed: Nov. 14, 2013

(30) Foreign Application Priority Data
Jan. 2, 2013 (KR) 10-2013-0000122

(51) Int. Cl. H04L 29/06

(52) U.S. Cl. CPC H04L 63/1458
USPC 726/23

(57) ABSTRACT

An OpenFlow switch in an OpenFlow environment includes an attack determination module to collect statistical information on packet processing with respect to incoming packets to be processed in the OpenFlow switch at a predetermined period interval to determine whether a DDoS attack occurs. The Openflow switch also includes an attack responding module to perceive a feature of the DDoS attack by using the incoming packets introduced into the OpenFlow switch after the determination of the occurrence of the DDoS attack and process the incoming packets in line with the perceived feature of the DDoS attack. Therefore, it is possible to determine and responds to DDos attacks in the OpenFlow switches.

### CROSS-REFERENCE TO RELATED APPLICATION

This application claims the benefit of Korean Patent Application No. 10-2013-0000122, filed on Jan. 2, 2013 which is hereby incorporated by reference as if fully set forth herein.

### FIELD

The present invention relates to a technique of processing a Distributed Denial of Service (DDos) attack in an OpenFlow environment, and more particularly, to a DDoS attack processing apparatus and method in OpenFlow switches to receive incoming packets, which is capable of determining and responding to DDos attacks in the OpenFlow switches.

### BACKGROUND

An OpenFlow technique is a technique to construct a virtual network optimized in each service on a physical network for operation of the virtual network. The virtual network includes an OpenFlow controller for controlling centrally the entire network, OpenFlow switches for processing incoming data packets that are introduced into the OpenFlow switches under a control scheme settled by the OpenFlow controller, and an OpenFlow protocol that is responsible for communication between the OpenFlow switch and the OpenFlow controller.

On the other hand, a DDoS attack is an attempt to employ several hundred of thousands of zombie PCs and send massive attack traffics to a target server causing the server to deny normal services.

The DDoS attack may occur even in an OpenFlow environment. More specifically, at the time of the receipt of unrecognized incoming packets, the switches send signaling messages to the controller, and the controller then transfers processing information related to the packets to all the switches that need to participate in processing the packets. For example, if the number of the switches under the control of the controller is ‘N’, and all the switches participate in the packet processing, the controller generates the maximum ‘N’ number of signaling messages to transfer them to all the switches. In other words, in order to process one new flow, the controller should process the maximum N+1 number of signaling messages.

Meanwhile, a DDoS attacker generates several hundred of thousands of flows exploiting several hundred of thousands of zombie PCs (assuming it to be M) that the switches are not recognizable to attack the switches. The switches inquire of the controller how to process the M number of unrecognizable flows in such a manner as described above, and hence the controller should process the maximum M*(N+1) number of signaling messages.

That is, the reason why the DDoS attack in the OpenFlow environment results in obstacles much larger than an existing DDoS attack is that the attacker attacks all the switches managed by the controller, i.e., the N number of switches, instead of attacking only one switch. In this case, the controller needs to process as many as the N*M*(N+1) number of signaling messages. The processing of these messages causes the controller to fall into a denial of services. For example, it is assumed that the controller manages 10 numbers of switches, the attacker produces 100,000 numbers of flows, and an attack is performed by changing source IPs and ports every minute. The controller 10 then processes ten million or more signaling packets per minute, which results in falling into a denial of service.

In the OpenFlow environment, the other serious security vulnerability is that, in the technical nature, it is extremely difficult to determine whether a DDoS attack occurs. In general, the determination of the occurrence of the DDoS attack needs to perceive header information of the incoming packets in real-time and rapidly identify an unusual feature of the attack traffics, for example, a sudden increase in a ratio of ICMP packets to overall traffics. In other words, the determination of the DDoS attack can be achieved by an apparatus or module that is capable of observing the header information of all incoming packets in real time.

The OpenFlow is a technique which allows the controller to dedicate to a network and flow control function and the switches to dedicate to only packet forwarding in a manner as prescribed by the controller. Therefore, the determination of the DDoS attack is done by the controller, which is responsible for control functions. This leads to a security vulnerability in the OpenFlow technology. As mentioned above, it is because that whether the DDoS attack occurs should be made through the inspection of the packet header information, but these packet-processing task is done by the switches used to role of packet forwarding instead of the controller. In other words, the reason is that the controller, which is responsible for determining whether the DDoS attack occurs, receives only information on the overview of the number of packets, the number of bytes and the like that are processed and transmitted by the switches every particular cycle and does not process the packets.

Therefore, there are limitations in determining whether the DDoS attack occurs with only the overview information in terms of overhead, in terms of time, and in terms of accuracy. First, from the standpoint of time, the controller receives information from the switches at least two or three times at a specific periodic interval, compares between the differences of the received information, and roughly estimates whether the DDoS attack occurs. After that, for accurate judgment, the controller sends signaling messages onto the switches, requests the switches to transmit detailed information necessary for detecting the DDoS attack, and receives the detailed information to determine whether the attack finally occurs. When it is determined that the attack has happened, a countermeasure should be established and transferred back to the switches via signaling messages for setting the switches. During that time, the OpenFlow network has already damaged by an attacker.

Secondly, in terms of overhead, the controller requests the switches to send the detailed information necessary to determine whether the attack occurs. In this regard, the controller may request only the number of packets and number of bytes that have been processed by each interface of the switches, but the controller may request detailed information on the number of packets and number of bytes that have been processed by a group, by a table and by its table entry as well as by the interface of the switches in order to increase the accuracy. However, the information may be a significant overhead to the controller since the number of table entries amounts to several thousand to several tens of thousands and the controller requests the detailed information of all the switches that are managed by the controller. Further, as mentioned above, the controller additionally process as many as the total N*M*(N+1) number of signaling messages every minute, and hence the controller becomes rapidly fall into a denial of service.

Finally, in terms of accuracy, the DDoS attack can be typically determined as a signature-based attack and a behavior-based attack. However, it is difficult for the controller to determine accurately whether the signature-based attack and behavior-based attack occur through the use of only the information on the number of packets and bytes that can be obtained from the switches.

As such, it is difficult to determine whether the DDoS attack occurs with only the overview information sent by the switches, and even if determined, not only it may take a long time for the determination, but also the accuracy of the determination may degrade significantly.

Even if the controller successfully determines the occurrence of the DDoS attack based on statistical information that has been sent from the switches, the most difficult problem is to judge which flow is sent by the attacker and which source is a zombie PC.

This is the reason that the processing on the packets is directly done on the switches with no responding capability against the DDoS attack, but the DDoS attack substantially happens in the controller to take advantage of statistical-based indirect information that is transmitted from the switches.

As mentioned earlier, therefore, the response to the DDoS attack should be made on an apparatus that can inspect the header information of all the incoming packets in real time, e.g., the switches for the OpenFlow technology.

### SUMMARY

In view of the above, the present invention provides an apparatus and method for determining whether a DDoS attack occurs and responding to the DDoS attack, which is mounted in OpenFlow switches and capable of determining whether the DDoS attack occurs and responding to the DDoS attack by the switches themselves.

In accordance with an aspect of the exemplary embodiment of the present invention, there is provided an OpenFlow switch in an OpenFlow environment, which includes: an attack determination module configured to collect statistical information on packet processing with respect to incoming packets to be processed in the OpenFlow switch at a predetermined period interval to determine whether a DDoS attack occurs; and an attack responding module configured to perceive a feature of the DDoS attack by using the incoming packets introduced into the OpenFlow switch after the determination of the occurrence of the DDoS attack and process the incoming packets in line with the perceived feature of the DDoS attack.

In the embodiment, the attack determination module includes: a packet capture unit configured to capture the incoming packets introduced into the OpenFlow switch when the occurrence of the DDoS attack is determined, wherein the captured packets are provided to the attack responding module.

In the embodiment, the attack determination module is configured to determine whether the DDoS attack occurs based on the number of packets or bytes processed every a predetermined period and a predetermined threshold.

In the embodiment, the attack responding module includes: a signature-based responding unit configured to determine whether the signature-based attack DDoS occurs by analyzing the overall traffics occurred in the OpenFlow switch and the traffics occurred in ICMP (Internet Control Message Protocol), TCP (Transmission Control Protocol), UDP (User Datagram Protocol), or HTTP (Hyper Text Transfer Protocol) and performs a disposal process for the incoming packets; and a behavior-based responding unit configured to determine whether a behavior-based attack occurs by analyzing the incoming packet when it is determined that the attack is not the signature-based attack and performs a disposal process for the incoming packets.

In the embodiment, the signature-based responding unit is configured to determine: that the signature-based attack is an ICMP attack when a ratio of ICMP traffics to the overall traffics is larger than a predetermined threshold of an ICMP traffic ratio; that the signature-based attack is a TCP attack when a ratio of TCP traffics to the overall traffics is larger than a predetermined threshold of a TCP traffic ratio; that the signature-based attack is a UDP attack when a ratio of UDP traffics to the overall traffics is larger than a predetermined threshold of a UDP traffic ratio; and that the signature-based attack is an HTTP attack when a ratio of HTTP traffics to the overall traffics is larger than a predetermined threshold of an HTTP traffic ratio.

In the embodiment, the signature-based attack responding unit is configured to perform a disposal process for the incoming packets related to the protocol under the signature-based attack.

In the embodiment, the OpenFlow switch further includes an information collection module configured to collect the feature of the DDoS attack and stores the collected feature in a database.

In the embodiment, the attack determination module is configured to determine that the DDoS attack occurs based on the feature of the DDoS attack stored in the database.

In the embodiment, the attack responding module is configured to perceive the DDoS attack based on the feature of the DDoS attack stored in the database.

In accordance with another aspect of the exemplary embodiment of the present invention, there is provided a method for processing a DDoS attack using an OpenFlow switch in an OpenFlow environment, which includes: collecting statistical information on packet processing with respect to incoming packets to be processed in the OpenFlow switch at a predetermined period interval; determining whether the DDoS attack occurs on a basis of the collected statistical information on packet processing; perceiving a feature of the DDoS attack using the incoming packets introduced into the OpenFlow switch when it is determined that the DDoS attack has happened; and processing the incoming packets in line with the feature of the DDoS attack.

In the embodiment, the determining whether the DDoS attack occurs comprises determining whether the DDoS attack occurs based on the number of packets or bytes processed every a predetermined period and a predetermined threshold.

In the embodiment, the processing the incoming packets includes: determining whether a signature-based attack DDoS occurs by analyzing the overall traffics occurred in the OpenFlow switch and the traffics occurred in ICMP (Internet Control Message Protocol), TCP (Transmission Control Protocol), UDP (User Datagram Protocol), or HTTP (Hyper Text Transfer Protocol); determining whether a behavior-based attack occurs by analyzing the incoming packet when it is determined that the signature-based attack has not happened; and processing the incoming packets related to the determined attack by discarding them.

In the embodiment, the determining that the signature-based attack occurs includes: determining that the signature-based attack is an ICMP attack when a ratio of ICMP traffics to the overall traffics is larger than a first predetermined threshold; if the ratio of ICMP traffics is equal to or less than the first predetermined threshold, determining that the signature-based attack is a TCP attack when a ratio of TCP traffics to the overall traffics is larger than a second predetermined threshold; if the ratio of TCP traffics is equal to or less than the second predetermined threshold, determining that the signature-based attack is a UDP attack when a ratio of UDP traffics to the overall traffics is larger than a third predetermined threshold; and if the ratio of UDP traffics is equal to or less than the third predetermined threshold, determining that the signature-based attack is an HTTP attack when a ratio of HTTP traffics to the overall traffics is larger than a four predetermined threshold.

In the embodiment, the method further includes: collecting the features of the perceived DDoS attack; and storing the collected features in a database.

In accordance with the embodiments of the present invention, the apparatus for determining whether the DDoS attack occurs and responding to the DDoS attack is installed in the respective OpenFlow switches, thereby minimizing the load due to the massive messages sent to the controller at the time of the DDoS attack while rapidly returning the OpenFlow network to a stable state.

Also, in terms of time, overhead and accuracy, as compared to the conventional controller-based device for defending against the DDoS attack using the limited state information, the apparatus for determining whether the DDoS attack occurs and responding to the DDoS attack of the embodiment demonstrates the excellent defense performance against the DDoS attack, and, therefore, a customized network can be further stably provided to a service provider trying to create a new service through the use of the OpenFlow technology.

### BRIEF DESCRIPTION OF THE DRAWINGS

The above and other objects and features of the present invention will become apparent from the following description of the embodiments given in conjunction with the accompanying drawings, in which:

FIG. 1 is a network diagram illustrating an OpenFlow technology to which an exemplary embodiment of the present invention is applied;

FIG. 2 shows a configuration of an OpenFlow switch in accordance with an exemplary embodiment of the present invention;

FIG. 3 is a block diagram of a DDoS attack processing apparatus in accordance with an exemplary embodiment of the present invention;

FIG. 4 illustrates a flow chart of a process for determining whether a DDoS attack occurs and responding to the DDoS attack performed by the DDoS attack processing apparatus shown in FIG. 1 in accordance with an exemplary embodiment of the present invention; and

FIG. 5 illustrates a flow chart of a process for responding to the DDoS attack in accordance with an exemplary embodiment of the present invention.

### DETAILED DESCRIPTION

Advantages and features of the invention and methods of accomplishing the same may be understood more readily by reference to the following detailed description of preferred embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

In describing the embodiments of the invention, known functions or configuration will not be described fully if the detailed description thereof makes the scope and spirit of the invention ambiguous. The following terms are defined in consideration of functions in the embodiments of the invention and may vary in accordance with the intentions of a user or an operator or according to usual practice. Therefore, the definitions of the terms should be interpreted on the basis of the entire content of the specification.

Hereinafter, the exemplary embodiments of the present invention will be described in detail with reference to the accompanying drawings.

Before describing the exemplary embodiment, an OpenFlow technology to which the exemplary embodiment is applied will be described as follows.

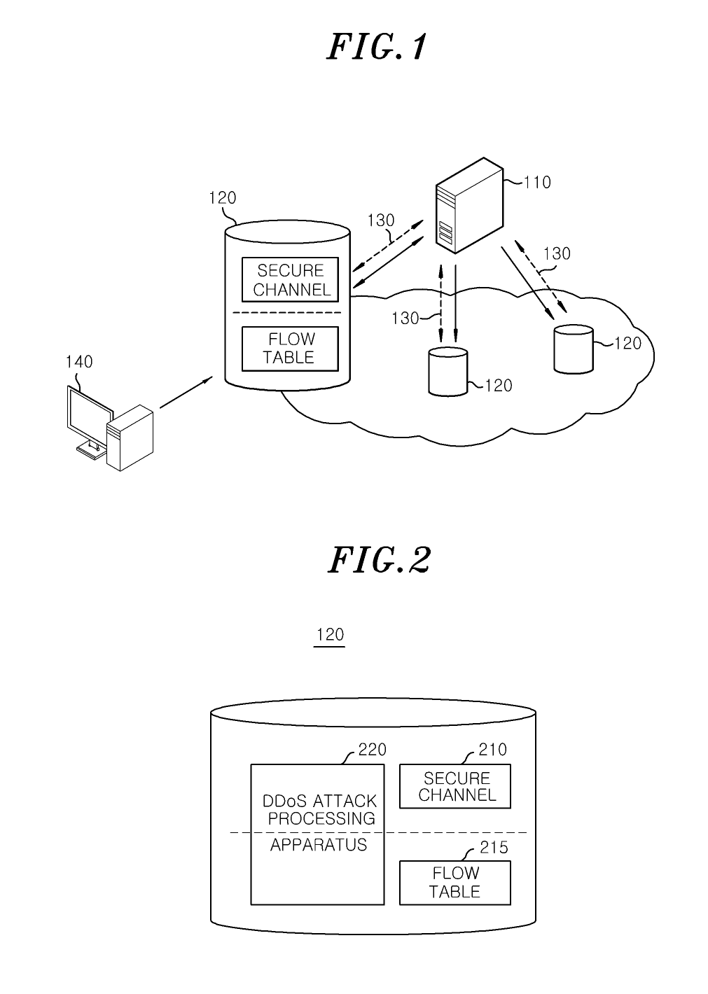

FIG. 1 is a network diagram illustrating an OpenFlow technology to which an exemplary embodiment of the present invention is applied.

Referring to FIG. 1, a virtual network to which the embodiment is applied includes an OpenFlow controller 110 for controlling centrally the entire network, a plurality of OpenFlow switches 120 for processing incoming data packets that are introduced into the OpenFlow switches under a control scheme settled by the OpenFlow controller 110, an OpenFlow protocol 130 that is responsible for communication between the OpenFlow controller 110 and the OpenFlow switches 120, and a terminal 140 such as a personal computer for transmitting the data packets to the OpenFlow switches 120 and receiving the data packets through the OpenFlow switches 120. Also, each of the OpenFlow switches 120 may be constructed with a hardware part having a flow table for processing the data packets and a software part for providing a secure channel.

Following is a description on a process performed when a new flow is introduced into the virtual network optimized to serve a particular service.

First, when data packets of a new flow are introduced into the OpenFlow switches 120, the OpenFlow switches 120 transmit signaling packets to inquire of the OpenFlow controller 110 how to process the flow since they have no processing information on the flow to which the packets belongs.

The OpenFlow controller 110 decides a processing method for the flow on a basis of status information of the OpenFlow switches 120 on the virtual network and transmits the processing method to all the OpenFlow switches 120 to which the packets belonging to the flow are delivered.

The OpenFlow switches 120, in response to the receipt of the processing method, processes the incoming packets in line with the processing method.

In the exemplary embodiment of the present invention, the OpenFlow switches 120 are designed to determine whether an exterior invasion, e.g., a DDoS attack, occurs and responds to the invasion.

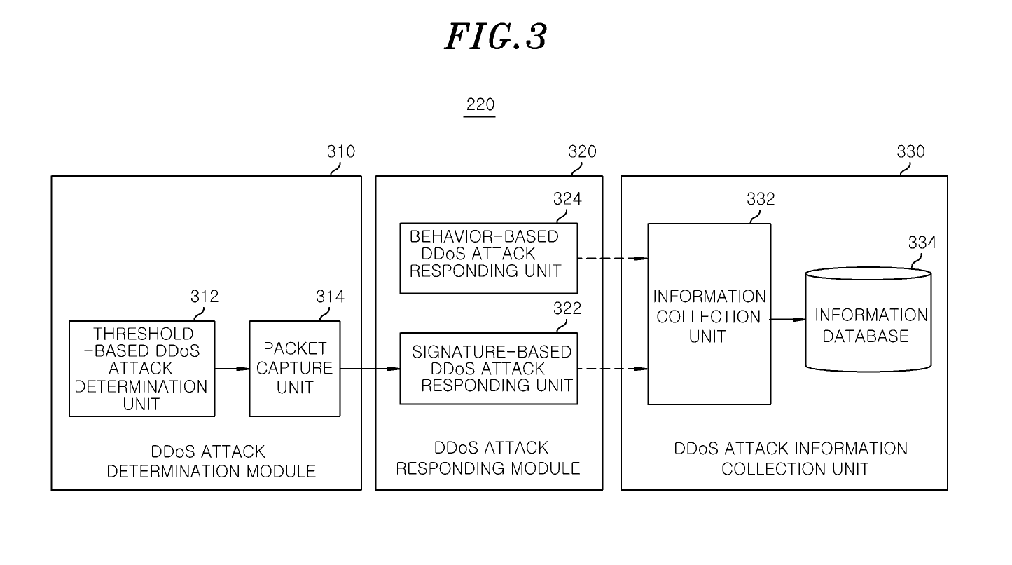

The configuration and operation of the OpenFlow switch 120 will be discussed with reference to FIG. 2 to FIG. 5.

FIG. 2 shows a configuration of one OpenFlow switch 120 among others in accordance with an exemplary embodiment of the present invention. The OpenFlow switch 120 includes a secure channel 210, a flow table 215 and a DDoS attack processing apparatus 220.

The DDoS attack processing apparatus 220 collects statistical information on the packet processing from the hardware part of the OpenFlow switch 120 and determines whether the DDoS attack occurs on a basis of the collected statistical information on the packet processing.

When it is determined that the DDoS attack has happened, the DDoS attack processing apparatus 220 inspects the headers of the incoming packets or sampled packets introduced onto the hardware part so that it can respond to the DDoS attack. More specifically, the DDoS attack processing apparatus 220 determines whether the attack is a signature-based DDoS attack or a behavior-based DDoS attack through the inspection of the headers and responds to the DDoS attack by processing the packets related to the DDoS attack, e.g., discarding the related packets in accordance with the determination.

The configuration and functionality of the DDoS attack processing apparatus 220 will be described with reference to FIG. 3.

FIG. 3 is a block diagram of a DDoS attack processing apparatus 220 in accordance with an exemplary embodiment of the present invention;

Referring to FIG. 3, the DDoS attack processing apparatus 220 includes a DDoS attack determination module 310, a DDoS attack responding module 320 and a DDoS attack information collection module 330.

The DDoS attack determination module 310, which is located on the hardware part of the OpenFlow switch 120, receives the statistical information on packet processing from the hardware part and determines whether the DDoS attack occurs on a basis of the received statistical information on packet processing and pre-stored feature information on the DDoS attack. Herein, the feature information on the DDoS attack may be information collected by the DDoS attack information collection module 330.

The DDoS attack determination module 310 may include a threshold-based DDoS attack determination unit 312 for determining whether the DDoS attack occurs on a basis of a predetermined threshold and a packet capture unit 314 for capturing the packets with the determination of the DDoS attack.

The threshold-based DDoS attack determination unit 312 determines that the DDoS attack had happened when there is a sudden increase in the number of packets and bytes at a specific period via the packet processing statistical information obtained every period. In other words, when the number of packets and bytes being processed at a current period is larger than a predetermined threshold in comparison with the number of packets and bytes processed at a previous period, the threshold-based DDoS attack determination unit 312 determines the occurrence of the DDoS attack, and the packet capture unit 314 captures the incoming packets introduced into the OpenFlow switch 120 to provide the captured packets to the DDoS attack responding module 320. In this regard, the predetermined threshold may be dynamically set in line with a network situation.

The DDoS attack responding module 320 analyzes the increase in a traffic ratio from the captured packets and perceives the signature-based DDoS attack with the analyzed traffic ratio, thereby responding to the signature-based DDoS attack.

Further, the DDoS attack responding module 320 analyzes the features of the captured packets if the attack is not the signature-based DDoS attack and perceives the behavior-based DDoS attack with the analyzed feature, thereby responding to the behavior-based DDoS attack.

The DDoS attack responding module 320 includes a signature-based DDoS attack responding unit 322 and a behavior-based DDoS attack responding unit 324.

The signature-based DDoS attack responding unit 322 may respond to a standardized type of DDoS attacks. That is, the signature-based DDoS attack responding unit 322 analyzes the increase in the traffic ratio from the captured packets to perceive the feature of the signature-based DDoS attack. Herein, the traffic may include ICMP (Internet Control Message Protocol) traffic, TCP (Transmission Control Protocol) traffic, UDP (User Datagram Protocol) traffic, HTTP (Hyper Text Transfer Protocol) traffic and the like, and the analysis of the traffic ratio increase may be made through the comparison between the predetermined threshold and the increased traffic ratio of the overall traffics in the OpenFlow switch.

The signature-based DDoS attack responding unit 322 performs a disposal process for the incoming packets when the feature of the signature-based DDoS attack is detected, thereby responding to the signature-based DDoS attack.

The behavior-based DDoS attack responding unit 324 responds to an unstandardized type of DDoS attacks. That is, the behavior-based DDoS attack responding unit 324 perceives the attack to be the unstandardized type of DDoS attacks, i.e., the behavior-based DDoS attack if the attack is not the signature-based DDoS attack, thereby responding to the behavior-based DDoS attack.

The behavior-based DDoS attack responding unit 324 responds to the behavior-based DDoS attack by discarding the incoming packets when the feature of the behavior-based DDoS attack is perceived.

Meanwhile, the feature of signature-based DDoS attack or the behavior-based DDoS attack may be provided to the information collection module 330.

The information collection module 330 includes an information collection unit 322 for collecting the feature of the DDoS attack obtained in the course of responding to the DDoS attack and an information database 334 that stores the collected features.

The feature information stored in the information collection unit 332 may be provided to the DDoS attack determination module 310 and the DDoS attack responding module 320. In response thereto, the DDoS attack determination module 310 can update information necessary for determining whether the DDoS attack occurs, and the DDoS attack responding module 320 can update information necessary for responding to the DDoS attack.

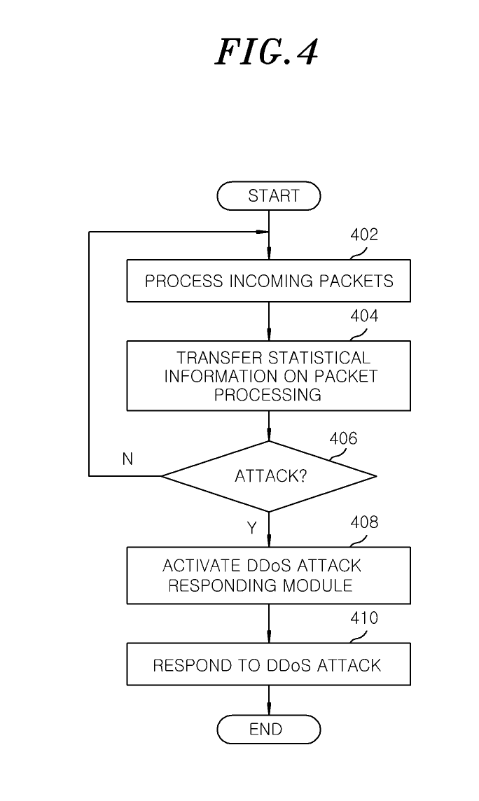

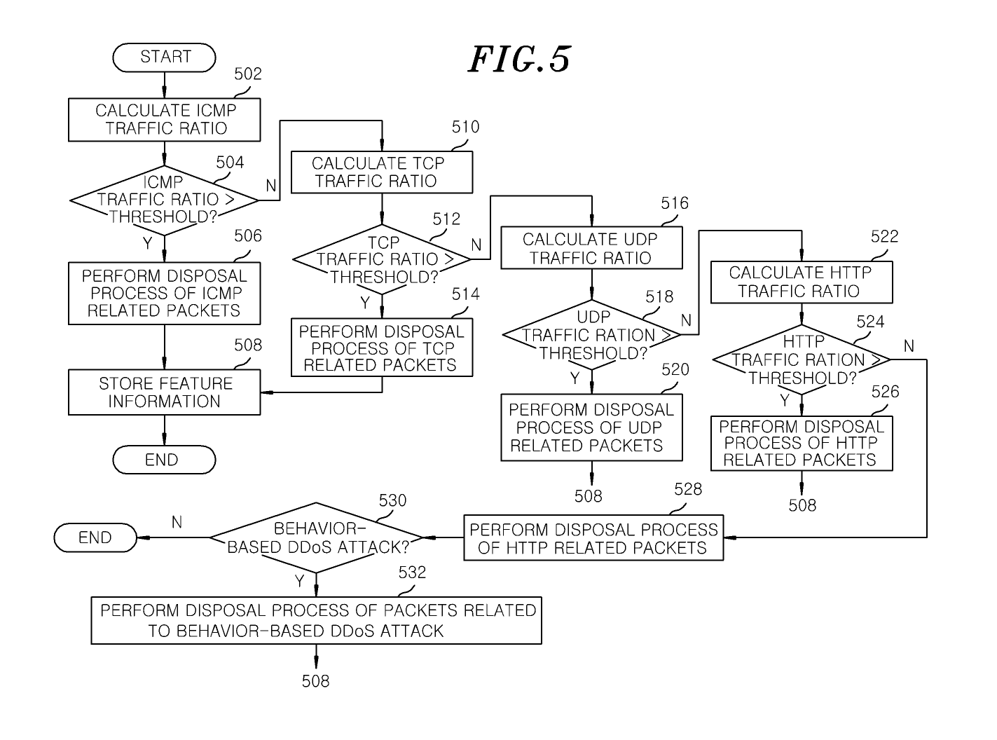

A process in which the OpenFlow controller 110 determines whether the DDoS attack occurs and responds to the DDoS attack will be described with reference to FIG. 4.

FIG. 4 illustrates a flow chart of a process for determining and responding to the DDoS attack performed by the OpenFlow controller 110 in accordance with an exemplary embodiment of the present invention.

Referring to FIG. 4, the OpenFlow switch 120 processes the packets on the hardware part in operation 402 and transfers the statistical information on the packet processing, for example, the number of processed packets and bytes every predetermined period onto the software part in operation 404.

In response thereto, the DDoS attack determination module 310 residing on the software part determines whether the DDoS attack occurs on a basis of the transferred statistical information in operation 406. For example, the threshold-based DDoS attack determination unit 312 may determine whether the DDoS attack occurs by comparing between the predetermined threshold and the number of the packets and bytes received at current as compared to the number of packets and bytes transferred at a current period. That is, it may be determined that the DDoS attack has begun in a case where the number of packets and bytes transferred at the current period is greater than the predetermined threshold.

As a result of the determination in operation 406, if it is determined that the DDoS attack has happened, the DDoS attack determination module 310 activates the DDoS attack responding module 320 in operation 408, and thus the DDoS attack responding module 320 responds to the DDoS attack targeting the incoming packets introduced into the OpenFlow switch 120 or the sampled packets while residing at the hardware part in operation 410.

Meanwhile, as the result of the determination in operation 406, if it is determined that none DDoS attack has happened, a process returns to the operation 402 to repeat the above operations. In other words, the OpenFlow switches 120 processes the incoming packets based on the information in the flow table 215 and transfers the statistical information on the packets processed every period onto the software part.

A process of responding to the DDoS attack to be performed in operation 410 will be described with reference to FIG. 5.

FIG. 5 illustrates a flow chart of a process for responding to the DDoS attack in accordance with an exemplary embodiment of the present invention.

Referring to FIG. 5, the DDoS attack responding module 320 determines whether the attack is the signature-based attack through the use of the signature-based DDoS attack responding unit 322. More specifically, the signature-based DDoS attack responding unit 322 calculates a ratio of the ICMP traffics to the total traffics in the OpenFlow switch 120 in operation 502 and determines whether the calculated ratio of the ICMP traffics is larger than a predetermined threshold of the ICMP traffic ratio in operation 504.

As a result of the determination in operation 504, if the calculated ratio of the ICMP traffics is larger than the predetermined threshold of the ICMP traffic ratio, the signature-based DDoS attack responding unit 322 determines that the attack is the signature-based attack, discards the ICMP related packets of the incoming packets and provides the feature information of the ICMP DDoS attack to the DDoS attack information collection module 330 in operation 506. In response thereto, the DDoS attack information collection module 330 stores the feature information of the ICMP DDoS attack in the information database 334 in operation 508.

Meanwhile, as a result of the determination in operation 504, if the calculated ratio of the ICMP traffics is equal to or less than the predetermined threshold of the ICMP traffic ratio, the signature-based DDoS attack responding unit 322 calculates a ratio of the TCP traffics to the total traffics in operation 510 and determines whether the calculated ratio of the TCP traffics is larger than a predetermined threshold of the TCP traffic ratio in operation 512.

As a result of the determination in operation 512, if the calculated ratio of the TCP traffics is larger than the predetermined threshold of the TCP traffic ratio, the signature-based DDoS attack responding unit 322 determines that the attack is the TCP attack, that is, TCP flooding, discards the TCP related packets of the incoming packets and provides the feature information of the TCP DDoS attack to the DDoS attack information collection module 330 in operation 514. In response thereto, the DDoS attack information collection module 330 stores the feature information of the TCP DDoS attack in the information database 334 in operation 508.

Meanwhile, as a result of the determination in operation 512, if the calculated ratio of the TCP traffics is equal to or less than the predetermined threshold of the TCP traffic ratio, the signature-based DDoS attack responding unit 322 calculates a ratio of the UDP traffics to the total traffics in operation 516 and determines whether the calculated ratio of the UDP traffics is larger than a predetermined threshold of the UDP traffic ratio in operation 518.

As a result of the determination in operation 518, if the calculated ratio of the UDP traffics is larger than the predetermined threshold of the UDP traffic ratio, the signature-based DDoS attack responding unit 322 determines that the attack is the UDP attack, that is, UDP flooding, discards the UDP related packets of the incoming packets and provides the feature information of the UDP DDoS attack to the DDoS attack information collection module 330 in operation 520. In response thereto, the DDoS attack information collection module 330 stores the feature information of the UDP DDoS attack in the information database 334 in operation 508.

Meanwhile, as a result of the determination in operation 518, if the calculated ratio of the UDP traffics is equal to or less than the predetermined threshold of the UDP traffic ratio, the signature-based DDoS attack responding unit 322 calculates a ratio of the HTTP traffics to the total traffics in operation 522 and determines whether the calculated ratio of the HTTP traffics is larger than a predetermined threshold of the HTTP traffic ratio in operation 524.

As a result of the determination in operation 524, if the calculated ratio of the HTTP traffics is larger than the predetermined threshold of the HTTP traffic ratio, the signature-based DDoS attack responding unit 322 determines that the attack is the HTTP attack, that is, HTTP flooding, discards the HTTP related packets of the incoming packets and provides the feature information of the HTTP DDoS attack to the DDoS attack information collection module 330 in operation 526. In response thereto, the DDoS attack information collection module 330 stores the feature information on the HTTP DDoS attack in the information database 334 in operation 508.

Meanwhile, as a result of the determination in operation 524, if the calculated ratio of the HTTP traffics is equal to or less than the predetermined threshold of the HTTP traffic ratio, the signature-based DDoS attack responding unit 322 determines that the attack is not the signature-based attack to trigger the operation of the information database 334 in operation 528.

In response thereto, the behavior-based DDoS attack responding unit 324 analyzes all the packets introduced into the OpenFlow switches 120 or sampled packets to determine whether the attack is the behavior-based attack in operation 530.

If, in the operation 530, the attack is the behavior-based attack, the behavior-based DDoS attack responding unit 324 performs a disposal process for all the packets exploited in the behavior-based DDoS attack and provides the feature information on the behavior-based DDoS attack to the DDoS attack information collection module 330 in operation 532. In response thereto, the DDoS attack information collection module 330 stores the feature information on the behavior-based DDoS attack in the information database 334 in operation 508.

The feature information of the DDoS attacks stored in the information database 334 may be provided to the DDoS attack determination module 310 and the DDoS attack responding module 320 so that they can utilize the feature information as a reference data to determine whether the DDoS attack occurs and responds to the DDoS attack.

As mentioned above, in accordance with the exemplary embodiments of the present invention, an apparatus for determining whether the DDoS attack occurs and responding to the DDoS attack is installed in the respective OpenFlow switches so that the switches itself determines whether the DDoS attack occurs and responds to the DDoS attack, thereby not only minimizing the load due to the massive messages sent to the OpenFlow controller 110 at the time of the DDoS attack but also rapidly responding to the DDoS attack.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. An OpenFlow switch in an OpenFlow environment, the Openflow switch comprising:
an attack determination module configured to collect statistical information on packet processing with respect to incoming packets to be processed in the OpenFlow switch at a predetermined period interval to determine whether a DDoS attack occurs; and
an attack responding module configured to perceive a feature of the DDoS attack by using the incoming packets introduced into the OpenFlow switch after the determination of the occurrence of the DDoS attack and process the incoming packets in line with the perceived feature of the DDoS attack.

2. The OpenFlow switch of claim 1, wherein the attack determination module comprises:
a packet capture unit configured to capture the incoming packets introduced into the OpenFlow switch when the occurrence of the DDoS attack is determined, wherein the captured packets are provided to the attack responding module.

3. The OpenFlow switch of claim 1, wherein the attack determination module is configured to determine whether the DDoS attack occurs based on the number of packets or bytes processed every a predetermined period and a predetermined threshold.

4. The OpenFlow switch of claim 1, wherein the attack responding module comprises:
a signature-based responding unit configured to determine whether the signature-based attack DDoS occurs by analyzing the overall traffics occurred in the OpenFlow switch and the traffics occurred in ICMP (Internet Control Message Protocol), TCP (Transmission Control Protocol), UDP (User Datagram Protocol), or HTTP (Hyper Text Transfer Protocol) and performs a disposal process for the incoming packets; and
a behavior-based responding unit configured to determine whether a behavior-based attack occurs by analyzing the incoming packet when it is determined that the attack is not the signature-based attack and performs a disposal process for the incoming packets.

5. The OpenFlow switch of claim 4, wherein the signature-based responding unit is configured to determine:
that the signature-based attack is an ICMP attack when a ratio of ICMP traffics to the overall traffics is larger than a predetermined threshold of an ICMP traffic ratio;
that the signature-based attack is a TCP attack when a ratio of TCP traffics to the overall traffics is larger than a predetermined threshold of a TCP traffic ratio;
that the signature-based attack is a UDP attack when a ratio of UDP traffics to the overall traffics is larger than a predetermined threshold of a UDP traffic ratio; and
that the signature-based attack is an HTTP attack when a ratio of HTTP traffics to the overall traffics is larger than a predetermined threshold of an HTTP traffic ratio.

6. The OpenFlow switch of claim 5, wherein the signature-based attack responding unit is configured to perform a disposal process for the incoming packets related to the protocol under the signature-based attack.

7. The OpenFlow switch of claim 1, further comprising an information collection module configured to collect the feature of the DDoS attack and stores the collected feature in a database.

8. The OpenFlow switch of claim 7, wherein the attack determination module is configured to determine that the DDoS attack occurs based on the feature of the DDoS attack stored in the database.

9. The OpenFlow switch of claim 7, wherein the attack responding module is configured to perceive the DDoS attack based on the feature of the DDoS attack stored in the database.

10. A method for processing a DDoS attack using an OpenFlow switch in an OpenFlow environment, the method comprising:
collecting statistical information on packet processing with respect to incoming packets to be processed in the OpenFlow switch at a predetermined period interval;
determining whether the DDoS attack occurs on a basis of the collected statistical information on packet processing;
perceiving a feature of the DDoS attack using the incoming packets introduced into the OpenFlow switch when it is determined that the DDoS attack has happened; and
processing the incoming packets in line with the feature of the DDoS attack.

11. The method of claim 10, said determining whether the DDoS attack occurs comprises determining whether the DDoS attack occurs based on the number of packets or bytes processed every a predetermined period and a predetermined threshold.

12. The method of claim 10, wherein said processing the incoming packets comprises:
determining whether a signature-based attack DDoS occurs by analyzing the overall traffics occurred in the OpenFlow switch and the traffics occurred in ICMP (Internet Control Message Protocol), TCP (Transmission Control Protocol), UDP (User Datagram Protocol), or HTTP (Hyper Text Transfer Protocol);
determining whether a behavior-based attack occurs by analyzing the incoming packet when it is determined that the signature-based attack has not happened; and
processing the incoming packets related to the determined attack by discarding them.

13. The method of claim 12, said determining that the signature-based attack occurs comprises:
determining that the signature-based attack is an ICMP attack when a ratio of ICMP traffics to the overall traffics is larger than a first predetermined threshold;
if the ratio of ICMP traffics is equal to or less than the first predetermined threshold, determining that the signature-based attack is a TCP attack when a ratio of TCP traffics to the overall traffics is larger than a second predetermined threshold;
if the ratio of TCP traffics is equal to or less than the second predetermined threshold, determining that the signature-based attack is a UDP attack when a ratio of UDP traffics to the overall traffics is larger than a third predetermined threshold; and
if the ratio of UDP traffics is equal to or less than the third predetermined threshold, determining that the signature-based attack is an HTTP attack when a ratio of HTTP traffics to the overall traffics is larger than a four predetermined threshold.

14. The method of claim 10, further comprising:
collecting the features of the perceived DDoS attack; and
storing the collected features in a database.
